(19) United States
(12) Patent Application Publication
(10) Pub. No.: US 2006/0267321 A1
(43) Pub. Date: Nov. 30, 2006

(54) On-board vehicle seat capacitive force sensing device and method

(75) Inventors: Divyasimha Harish, Union City, CA (US); William D. Dallenbach, Sunnyvale, CA (US)

Correspondence Address: Raj Abhyanker, LLP;c/o Intellevate, LLC, P.O. Box 52050, Minneapolis, MN, 55402, US

(73) Assignee: Loadstar Sensors, Inc.

(21) Appl. No.: 11/441,679

(22) Filed: May 26, 2006

Related U.S. Application Data
(60) Provisional application No. 60/685,248, filed on May 27, 2005.

(51) Int. Cl. B60R 21/015

(52) U.S. Cl. 280/735

(57) ABSTRACT

An on-board vehicle seat capacitance force sensing apparatus/method is disclosed. In one embodiment, an apparatus includes capacitive sensors mounted between a base structure of a seat in a vehicle and rails of the seat. Each of the capacitive sensors includes a capacitor having an upper conductive surface and a lower conductive surface substantially parallel to the upper conductive surface, a housing with a cover plate to encompass the capacitor, and a sensor in the housing to generate a measurement based on a change in a distance between the upper conductive surface and the lower conductive surface when the cover plate is deflected by a force applied on the cover plate. The apparatus also includes an airbag associated with the seat to deploy based on a weight of an occupant of the seat obtained by aggregating the measurement.

### CLAIM OF PRIORITY

This application claims priority from the provisional application 60/685,248 titled “ON-BOARD SEAT WEIGHT MEASUREING SYSTEM USING CAPACITIVE FORCE SENSORS” filed on May 27^{th}, 2005.

### FIELD OF TECHNOLOGY

This disclosure relates generally to technical fields of measuring devices and, in one embodiment, to an on-board vehicle seat capacitance force sensing apparatus and method.

### BACKGROUND

An airbag deployment system may be a safety mechanism which protects an occupant (e.g., a driver, a passenger, etc.) of a vehicle when the vehicle crashes. The airbag deployment system may be triggered when the vehicle absorbs an impact beyond a predetermined threshold value (e.g., due to a crash and/or a rollover of the vehicle).

The occupant may be injured when the airbag (e.g., a front-impact airbag) deploys with an extreme force. The extreme force may be fatal for a child (e.g., under 12) and/or a small adult (e.g., of short stature) who may be riding in a passenger seat of the vehicle. A size of an airbag deployed in the vehicle may be too large to prevent an injury to the occupant when the occupant is leaning forward. Furthermore, the airbag may not benefit the occupant when the airbag designed to deploy towards a center of the seat misses the occupant leaning left or right. Therefore, the airbag may become a disservice to a safety of the occupant when the airbag is deployed indiscriminately during the crash and/or the rollover of the vehicle.

The airbag may be deployed even when the passenger seat is occupied by an object (e.g., a box, a bag, etc.). When this happens, an owner of the vehicle may have to go to automobile dealer to reconstruct the airbag for a later use. A visit to the automobile dealer to repair the airbag is time consuming and costly.

### SUMMARY

An on-board vehicle seat capacitance force sensing apparatus/method is disclosed. In one aspect, an apparatus includes capacitive sensors (e.g., four capacitive sensors each capable of weighing at least 200 pounds) mounted between a base structure of a seat in a vehicle and rails of the seat. Each of the capacitive sensors includes a capacitor having an upper conductive surface and a lower conductive surface substantially parallel to the upper conductive surface, a housing with a cover plate to encompass the capacitor, and a sensor in the housing to generate a measurement based on a change in a distance between the upper conductive surface and the lower conductive surface when the cover plate is deflected by a force applied on the cover plate. The apparatus also includes an airbag associated with the seat to deploy based on a weight of an occupant of the seat obtained by aggregating the measurement.

The apparatus may further include an electronic circuit connected to the capacitive sensors using either a wired communication and/or a wireless communication and a converter circuit (e.g., of the electronic circuit) to transform the measurement to a signal data (e.g., which includes a voltage data or a frequency data). The apparatus may also include an aggregation circuit to sum the signal data from the converter circuit (e.g., of the electronic circuit) to obtain the weight of the occupant and a detector circuit (e.g., of the electronic circuit) to generate a flag data when a temperature of the occupant measured by a temperature sensor installed on an outer surface of the seat matches a body temperature (e.g., 98.6 F) of a human.

Furthermore, the apparatus may include a classification circuit of the electronic circuit to categorize the occupant based on the weight of the occupant when the flag data (e.g., indicating the occupant is a person) is communicated to the classification circuit and a position circuit of the electronic circuit to approximate a posture of the occupant based on a distribution of the weight of the occupant across the capacitive sensors. The posture of the occupant may be additionally estimated using a smart sensor based on an electrical field system (e.g., to provide a real time analysis of the occupant's position as well as a mass of the occupant) and an ultrasound system (e.g., to determine an identity of the occupant using a high frequency sound and echo). The apparatus may further include and an airbag control circuit connected to the classification circuit to evaluate the weight and the posture of the occupant to deploy the airbag associated with the seat.

In another aspect, a method includes generating a weight data based on a sum of capacitances produced from capacitive sensors mounted under a vehicle seat when a weight of an occupant is applied on the vehicle seat and calculating a position of the occupant relative to the vehicle seat based on the weight data and a sensory data of the occupant (e.g., where the sensory data may include one or more of a visual data, an olfactory data, a textile data, an acoustic data, and a thermal data of the occupant obtained using sensor modules).

The method also includes classifying the occupant to a category (e.g., which may include an adult, a small adult, a child, an inanimate object, etc.) based on the weight data, processing a crash data in an occupant protection module when a vehicle having the vehicle seat crashes to generate the crash data, and deploying an airbag based on the category, the position, and the crash data.

The method may further include instantaneously determining an inflation rate of the airbag, a direction of the airbag, and a decision as to the deploying of the airbag when the crash data is communicated to the occupant protection module, and generating an audible warning message (e.g., a beeping sound, a voice message, etc.) when the weight of the occupant in a front passenger seat is lighter than a threshold value (e.g., which may have aimed to protect little children and/or individuals with special physical conditions). The method may be executed in a form of a machine-readable medium embodying a set of instructions that, when executed by a machine, cause the machine to perform any of the operations disclosed herein.

In yet another aspect, a vehicle may include a seat mounted on a floor of the vehicle and a capacitive sensor module mounted under the seat of the vehicle to measure a weight of the occupant. The vehicle also includes an electronic circuit module coupled to the capacitive sensor module to generate a classification data associated with the weight of the occupant and the body temperature of the occupant, and a heat detection module installed on a cover of the seat to measure and communicate a body temperature of the occupant to the electronic circuit module. In addition, the vehicle includes an airbag module to deploy an airbag toward the occupant based on the classification data when a crash sensor receives a trigger data from an accelerometer of the vehicle.

A size and a direction of the airbag toward the occupant may be controlled based on the classification data to substantially reduce a propagation of an impact absorbed by the vehicle to the occupant. The heat detection module (e.g., of the vehicle) may be installed on a substantial surface of the seat and on a seat-belt of the seat to analyze a position of the occupant when a body of the occupant registers heat on the heat detection module. The vehicle may further include a machine vision module of the vehicle to collect and communicate a physical movement of the occupant to generate the classification data with a minimal error.

Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a three-dimensional view of a force-measuring device having a sensor capacitor and a reference capacitor, according to one embodiment.

FIG. 2 is a two dimensional vertical view of a force-measuring device, according to one embodiment.

FIG. 3 is a three-dimensional view of an on-board vehicle seat capacitive force-measuring device, according to one embodiment.

FIG. 4 is a modular view of an electronic circuit coupled to the on-board vehicle seat capacitive force-measuring device of FIG. 3, according to one embodiment.

FIG. 5 is a process view of measuring a weight applied to the on-board vehicle seat capacitive force-measuring device of FIG. 3, according to one embodiment.

FIGS. 6A-D are illustrative diagrams of an occupant sitting in four different postures and corresponding weight distributions, according to one embodiment.

FIG. 7 is a table view of information processed in the electronic circuit of FIG. 4, according to one embodiment.

FIG. 8 is a modular diagram of the force-measuring device of FIG. 1 connected to a data processing system by a cable and of the force measuring device of FIG. 1 wirelessly connected to the data processing system, according to one embodiment.

FIG. 9 is a two-dimensional vertical diagram of a vehicle having a capacitive sensor module and an airbag control module, according to one embodiment.

FIGS. 10A-D are illustrative diagrams of four different types of occupants in a crash situation, according to one embodiment.

FIG. 11 is a flow diagram of classifying an occupant of a vehicle seat to a category and deploying an airbag based on the category, according to one embodiment.

Other features of the present embodiments will be apparent from the accompanying drawings and from the detailed description that follows.

### DETAILED DESCRIPTION

On-board vehicle seat capacitance force sensing apparatus/method is disclosed. In the following description, for purposes of explanation, numerous specific details are set forth in order to provide a thorough understanding of the various embodiments. It will be evident, however, to one skilled in the art that the various embodiments may be practiced without these specific details.

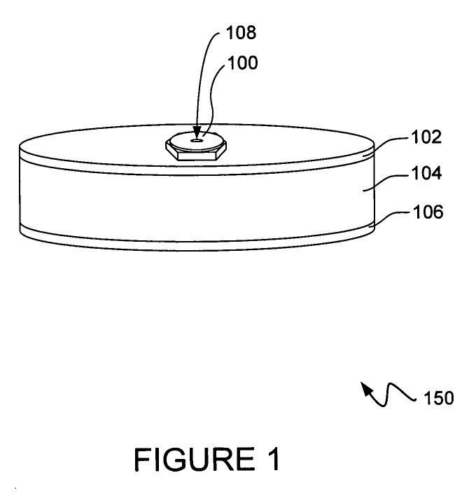

An example embodiment provides an apparatus including plurality of capacitive sensors (e.g., illustrated in FIGS. 1-3) mounted between a base structure of a seat in a vehicle and rails of the seat with each of the plurality of capacitive sensors (e.g., including a capacitor having an upper conductive surface and a lower conductive surface substantially parallel to the upper conductive surface, a housing with a cover plate to encompass the capacitor, and a sensor in the housing to generate a measurement based on a change in a distance between the upper conductive surface and the lower conductive surface when the cover plate is deflected by a force applied on the cover plate) and an airbag associated with the seat to deploy based on a weight of an occupant of the seat obtained by aggregating the measurement.

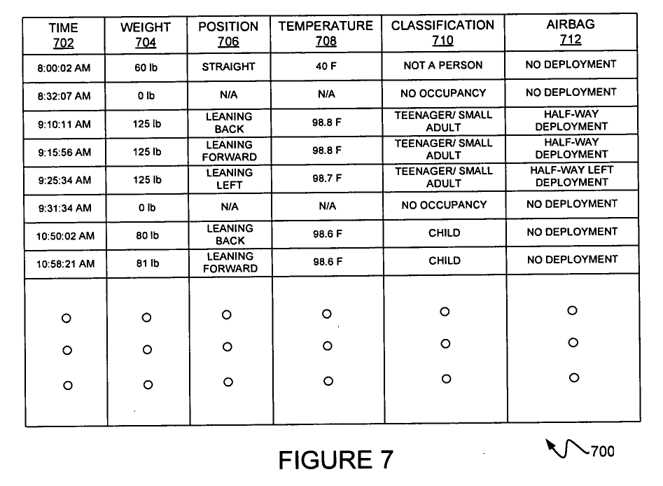

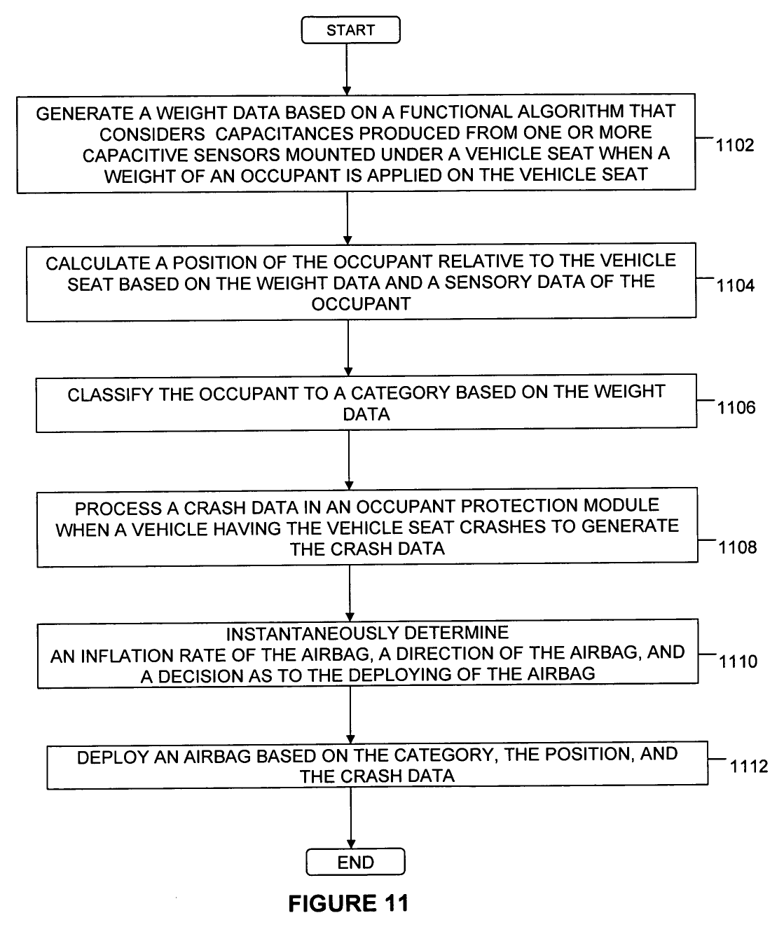

In addition, in another example embodiment, a method (e.g., displayed in FIG. 11) includes generating a weight data based on a sum of capacitances produced from a plurality of capacitive sensors mounted under a vehicle seat when a weight of an occupant is applied on the vehicle seat and calculating a position of the occupant relative to the vehicle seat based on the weight data and a sensory data of the occupant. The method also includes classifying the occupant to a category based on the data as in FIG. 7, processing a crash data in an occupant protection module when a vehicle having the vehicle seat crashes to generate the crash data, and deploying an airbag based on the category, the position, and the crash data. Also, the method may be in a form of a machine-readable medium embodying a set of instructions that, when executed by a machine, cause the machine to perform any method disclosed herein.

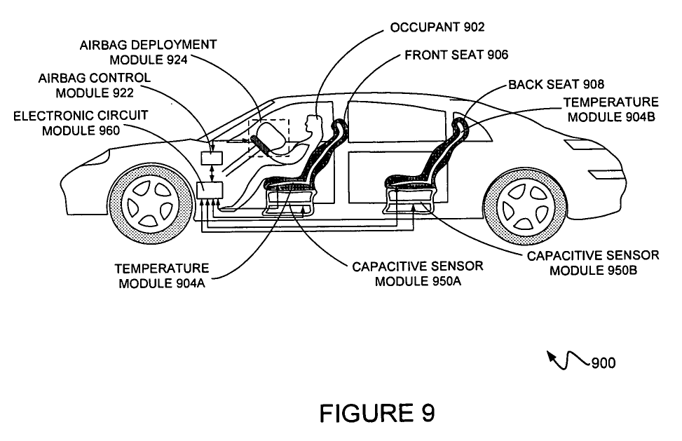

In yet another embodiment, a vehicle (e.g., as illustrated as an automobile in FIG. 9) includes a seat mounted on a floor of the vehicle, a capacitive sensor module mounted under the seat of the vehicle to measure a weight of the occupant, and an electronic circuit module coupled to the capacitive sensor module to generate a classification data associated with the weight of the occupant and a body temperature of the occupant. The vehicle also includes a heat detection module installed on a cover of the seat to measure and communicate the body temperature of the occupant with the electronic circuit and an airbag module to dispense an airbag toward the occupant based on the classification data when a crash sensor receives a trigger data from an accelerometer of the vehicle.

Example embodiments of a method and an apparatus, as described below, may be used to provide a high-accuracy, low-cost, and high-longevity on-board vehicle seat capacitance force sensing device (e.g., which may be based on load sensors, pressure sensors, etc.). It will be appreciated that the various embodiments discussed herein may/may not be the same embodiment, and may be grouped into various other embodiments not explicitly disclosed herein.

FIG. 1 is a three-dimensional view of a force-measuring device 150 having a sensor capacitor (e.g., a sensor capacitor consisting of two substantially parallel conductor surfaces) and a reference capacitor (e.g., a reference capacitor consisting of two substantially parallel conductor surfaces) according to one embodiment. The force-measuring device 150 (e.g., a cylindrical device, a square device, etc.) may include a top nut 100, a cover plate 102, a middle cylinder 104, and a bottom plate 106.

In one example embodiment, a force 108 (e.g., a load, a weight, a pressure, etc.) may be applied on top of the top nut 100 deflecting the cover plate 102. The cover plate 102 deflected by the force 108 may move down an upper conductor of the sensor capacitor toward a lower conduct of the sensor capacitor producing a change in capacitance. In another example embodiment, a housing (e.g., which may include the cover plate 102, the middle cylinder 104, and the bottom plate 106, or may include a different structure) may be made of a conductive and/or nonconductive material. In case the nonconductive material is being used, the nonconductive material may be painted (e.g., sputtered, coated, etc.) with the conductive material.

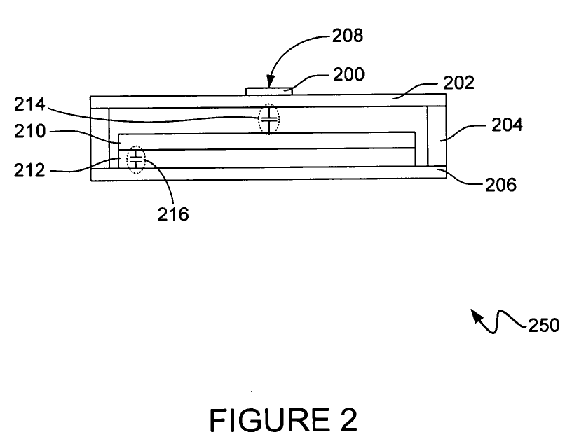

FIG. 2 is a two dimensional vertical view of a force-measuring device 250, according to one embodiment. The force-measuring device 250 encompasses a sensor capacitor 214, a reference capacitor 216, and a layered circuit in a housing (e.g., made of a conductive material and/or a nonconductive material to isolate any electronic module in the housing from an external electromagnetic noise).

In an example embodiment, the housing includes a cover plate 202, a middle cylinder 204, and a bottom plate 206. The sensor capacitor 214 may be formed between a painted conductor surface on a top center of a printed circuit board (PCB) 210 and a painted cavity created on a bottom surface of the cover plate 202 where the cavity is directly below a top nut 200 (e.g., which is located on a bottom surface of the cover plate 202). The cover plate 202, the PCB 210, and a spacer 212 may be adjoined together via fastening with a screw to a bottom inner chamber of the top nut 200.

A deflection of the cover plate 202 may cause a change in a distance between two parallel conductive surfaces of the sensor capacitor 214. The change in the distance may bring about a change in capacitance of the sensor capacitor 214. In one embodiment, the two parallel conductive surfaces are substantially parallel to each other and have the same physical area and/or thickness. The change in capacitance of the sensor capacitor 214 may be inversely proportional to the change in the distance between the two parallel conductive surfaces in one embodiment.

In another example, the reference capacitor 216 may be formed between a painted conductor surface on a bottom center of the PCB board 210 and a painted cavity created on a top surface of the bottom plate 206. The reference sensor may experience a change in capacitance only for environmental factors (e.g., humidity in a gap between the first conductive surface and the second conductive surface, a temperature of the force-measuring device 250, and an air pressure of an environment surrounding the force-measuring device 250, etc.). Therefore, the environmental factors can be removed from a measurement of a change in capacitance of the sensor capacitor when the force 208 is applied to the force-measuring device 250 (e.g., thereby allowing a user to determine the change in capacitance of the sensor capacitor more accurately).

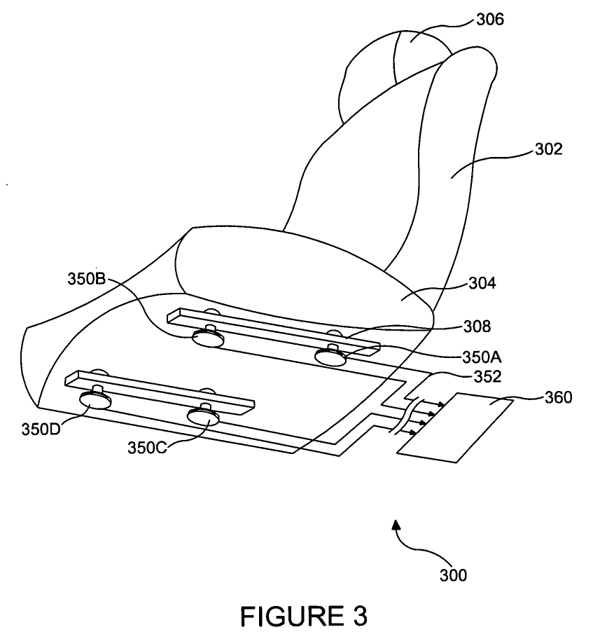

FIG. 3 is a three-dimensional view of an on-board vehicle seat capacitive force-measuring device 300 having a plurality of force-measuring devices 350, according to one embodiment. The on-board vehicle seat capacitive force-measuring device 300 includes a car seat having a back 302, a base 304, and a headrest 306, mounting rails 308 attached to a bottom of the car seat, the force-measuring devices 350, and one or more cables 352 connecting between the force-measuring devices 350 and an electronic circuit module 360.

The force-measuring devices 350 (e.g., four capacitive sensors with each capable of measuring at least 200 pounds) may be mounted between a base structure of the seat and the mounting rails 308. Each of the force-measuring devices 350 may be connected to the electronic circuit module 360 (e.g., which may process a measurement communicated from each of the force-measuring devices 350). In one example embodiment, an occupant (e.g., a passenger, a driver, an inanimate object, etc.) may sit on the seat applying the occupant's weight on the force-measuring devices 350A-N through the base 304 and to the mounting rails 308.

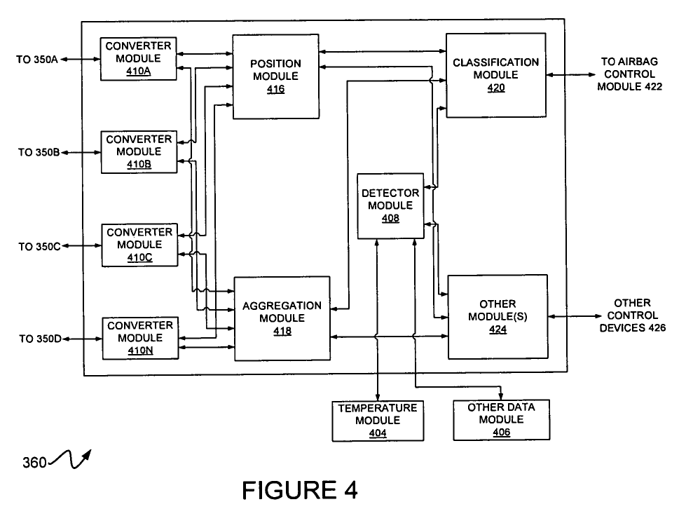

Accordingly, cover plates of the force-measuring devices 350 may be deflected reducing a distance between two conductive plates in each of the force-measuring devices 350. A measurement based on a change in the distance is generated in each of the force-measuring devices 350 individually communicated (e.g., wired and/or wireless) to the electronic circuit module 360. The electronic circuit module 360 is illustrated in more details in FIG. 4.

FIG. 4 is a modular view of an electronic circuit module 360 coupled to the on-board vehicle seat capacitive force-measuring device 300 of FIG. 3, according to one embodiment. The electronic circuit module 360 includes a detector module 408, converter modules 410, a position module 416, an aggregation module 418, a classification module 420, and other modules 424. Each of the converter modules 410 transforms the measurement generated by the sensor in each of the force-measuring devices 350.

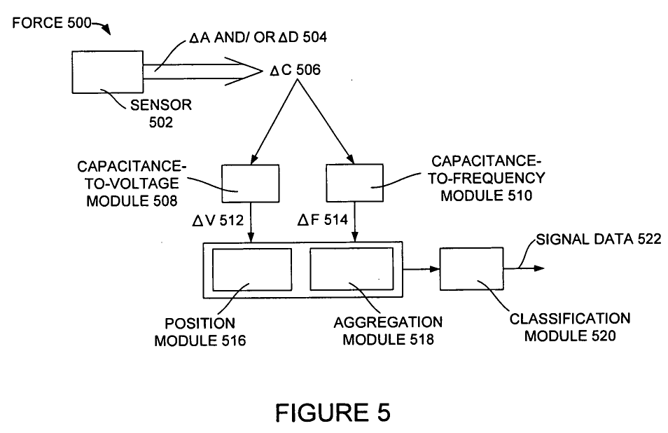

In one example embodiment, the converter module 410A may transform a capacitance communicated from a sensor of the force-measuring device 350A into a frequency data. In another example embodiment, the converter module 410A may transform a capacitance communicated from the sensor of the force-measuring device 350A into a voltage data. A working of the converter modules 410 is described in FIG. 5 in more details.

The aggregation module 418 may sum frequency data (e.g., voltage data, current data, etc.) produced by the converter modules 410 to measure a weight of the occupant sitting on the on-board vehicle seat capacitive force-measuring device 300 of FIG. 3. The detector circuit may generate a flag data when a temperature sensor (e.g., which may be installed on an outer surface of the vehicle seat) coupled to the detector circuit measures a temperature of the occupant in a vehicle seat equals to that of a human (e.g., around 98.6° F.).

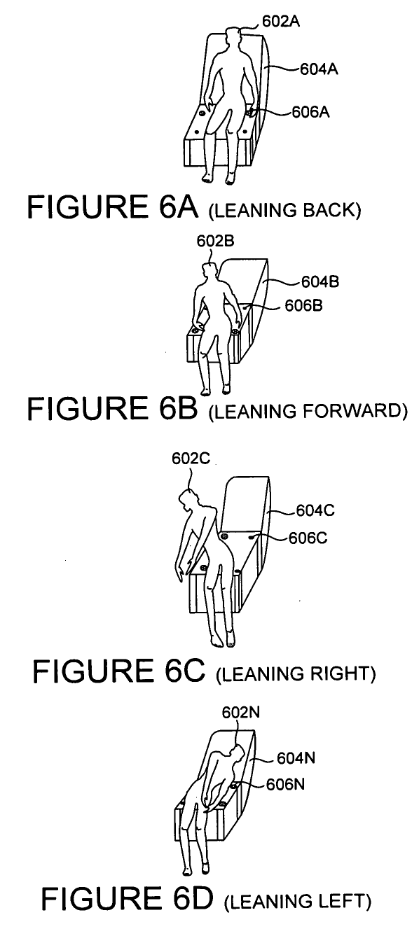

The position module 416 may be used to approximate a posture (e.g., similar to the occupant's location, stance, physical features, etc.) based on a distribution of the weight of the occupant across the plurality of capacitive sensors. For instance, FIG. 6 illustrates how the occupant's posture can be estimated using data processed in the position module 416. In FIG. 6A, an occupant 602A leans back resting his weight to a back rest of a vehicle seat 604A. In this posture, the occupant 602A may register more weight 606A toward a back side of the on-board vehicle seat capacitive force-measuring device 300 of FIG. 3 than a front side.

In FIG. 6B, an occupant 602B leans forward placing himself toward the front side of a vehicle seat 604B. In this posture, the occupant 602B may register more weight towards the front side of the on-board vehicle seat capacitive force-measuring device 300 of FIG. 3 than the back side. In FIG. 6C, an occupant 602C leans right willing his weight toward a right side of a vehicle seat 604C. In this posture, the occupant 602C may register more weight toward the right side of the on-board vehicle seat capacitive force-measuring device 300 of FIG. 3 than a left side.

In FIG. 6D, an occupant 602D leans left sliding toward the left side of a vehicle seat 604D. In this posture, the occupant 602D may register more weight on the left side of the on-board vehicle seat capacitive force-measuring device 300 of FIG. 3 than the right side. As illustrated here in FIGS. 6A-D, an approximation of a posture of an occupant may become more accurate as one or more sensors work in combination with the position module 416. For instance, the posture of the occupant may be estimated with a higher probability using a smart sensor based on or more of an electrical field system and an ultrasound system (e.g., other data module 406). In one example embodiment, the electrical field system provides a real time analysis of the occupant's position as well as the mass of the occupant. In another example embodiment, the ultrasound system may be installed on a dashboard to determine an identity of the occupant using a high-frequency sound and echo.

The classification module 420 may classify the occupant depending on the weight and/or other data (e.g., data from the temperature module 404 and/or other data module 406 which may collect sensory data including a visual data, an olfactory data, a textile data, and an acoustic data). In an example embodiment, the occupant can be categorized as an adult, an adult with a physical condition (e.g., where the physical condition such as shortness may put the adult in a danger due to a rapidness of an airbag being deployed), a child, and/or an inanimate object (e.g., when the temperature module 404 reports that the temperature of the occupant does not match a temperature of a human).

The classification module 420 may communicate a control data including a category of the occupant and/or the posture of the occupant to an airbag control module 422 (e.g., which may control a deployment of an airbag). The other modules 424 may provide tools to control other control devices (e.g., a door lock, a window lock, etc.) based on information obtained from the temperature module 404, the other data module 406, the detector module 408, the position module 416, and/or the aggregation module 418.

FIG. 5 is a process view of measuring a force 500, according to one embodiment. In FIG. 5, an electronic circuitry (e.g., a software and/or hardware code) may apply an algorithm to measure a change in a distance 504 between two conductive plates of the sensor 502 when the force 500 is propagated to the sensor 502. In an alternate embodiment, a change in area between the plates may be considered rather than the change in the distance.

Next, a change in capacitance 506 may be calculated based on the change in the distance 504 between the two plates forming the sensor capacitor. The change in capacitance 506, a change in voltage 512, and/or a change in frequency 514 may also be calculated to generate a measurement (e.g., an estimation of the force 500 applied to the sensor 502). The change in capacitance 506 may be changed into the change in voltage 512 using a capacitance-to-voltage module 508. The change in capacitance 506 may also be converted into the change in frequency 514 using a capacitance-to-frequency module 510.

Furthermore, the capacitance-to-frequency module 510 may be based on a circuit which produces a wave data with a frequency proportional to the change in capacitance 506. Thus, a higher resolution of the measurement may be possible when the frequency results in a high value (e.g., in million cycles per second) and/or is modulated to the high value. Thus, one may be able to obtain the change in frequency 514 of the sensor 502 by subtracting a number of wave forms per second when there is no force present from a number of wave forms per second when the force 500 is applied on the sensor 502.

The change in voltage 512 and/or the change in frequency 514 of the sensor 502 may be provided to the position module 516 and/or the aggregation module 518 to generate a signal data 522 (e.g., the posture and classification of the occupant) in a classification module 520.

FIG. 7 is a tabular view of information 700 processed in the electronic circuit module 360 of FIG. 3 and FIG. 4, according to one embodiment. The tabular view of information 700 may include a time 702, a weight 704, a position 706, a temperature 708, a classification 710, and an airbag 712. The time 702 may keep tracks of notable events such as an arrival and a departure of an occupant to a vehicle seat. The weight 704 may list a force applied by the occupant on the vehicle seat. The position 706 may display a posture of the occupant whenever there is any change in the posture. The temperature may display a body temperature of the occupant. The classification 710 may categorize the occupant based on one or more data (e.g., the weight 704, the position 706, the temperature 708, etc.). The airbag 712 display how an airbag is deployed based on the classification 710 and the position 706 of the occupant.

In one example embodiment, a box is placed in a front passenger seat of a vehicle at 8:00:02 AM. The electronic circuit may process and/or generate 60 lb as the weight 704 of the occupant (e.g., the box), “straight” in the position 706 section, 40 F as the temperature 708, and “not a person” as the classification 710. Based on the temperature, the classification module 420 of FIG. 4 categorized the occupant (e.g., the box) as “not a person.” Consequently, the airbag 712 will not deployed toward the front passenger seat even if the vehicle crashes and/or rolls over, according to one embodiment.

In another example embodiment, at 9:10:11 AM, an occupant (e.g., a teenager or a small adult) is occupying a vehicle seat. The occupant may be classified as the teenager or the small adult based on the weight (e.g., 125 lb) generated by an on-board vehicle seat capacitive force-measuring device 350 of FIG. 3. The position module 416 of FIG. 4 estimates a position of the occupant. A deployment of the airbag 712 may be conditioned by the classification 710 and/or the position 706. In this case, the airbag 712 was deployed half-way rather than by full-force. Here, the deployment of the airbag was influenced by a delicate nature of a person of the size (e.g., Airbag deployment schemes such as this may be programmed based on a guideline set by National Highway Traffic Safety Administration (NHTSA)).

In yet another example embodiment, an occupant of a passenger seat in a vehicle leans left when the vehicle had a collision with another vehicle. When the collision happened (e.g., at 9:25:34), the occupant was leaning left. The airbag 712 deployed in this case was half-way (e.g., inflated half way and/or deployed with a medium force). In addition, the airbag was deployed toward left in a direction of the occupant based on a reading of the position 706 of the occupant.

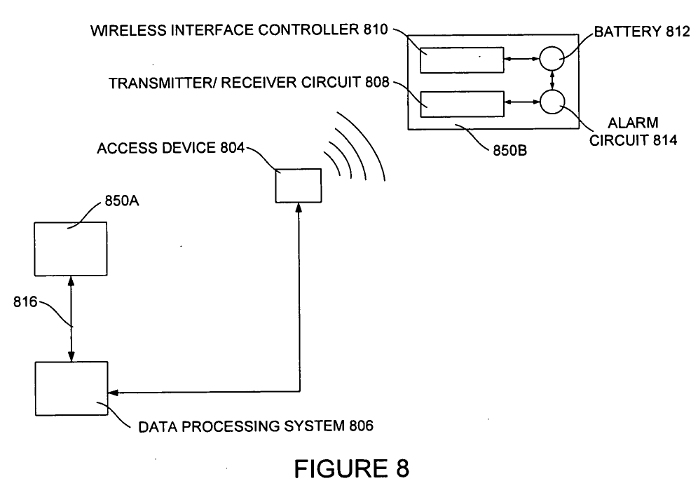

FIG. 8 is a modular diagram of a force-measuring device 850A connected to a data processing system 806 by a cable 816 and of a force-measuring device 850B wirelessly connected to the data processing system 806, according to one embodiment. The force-measuring device 850A is connected to a data processing system 806 through a cable 816 as illustrated in FIG. 8. The force-measuring device 850B includes a transmitter/receiver circuit 808 and a wireless interface controller 810 (e.g., for wireless communication), a battery 812 (e.g., to sustain as a standalone device), and an alarm circuit 814 (e.g., to alert a user when a force to the force-measuring device 850 B is greater than a threshold value and/or when the battery is almost out).

The data processing system 806 may receive data (e.g., output data measuring a force and/or a load, etc.) from the force-measuring device 850A and/or the force-measuring device 850B through cable 816 and an access device 804. In one embodiment, the data processing system 806 analyzes data (e.g., measurements) generated by various operation of the force-measuring devices 850. In another example embodiment, a universal serial bus (USB) may be included in a circuitry located on the PCB 210 of FIG. 2 of the force-measuring device 850A and/or the force-measuring device 850B. The USB (e.g., a USB port or hub with mini sockets) may allow a hardware interface (e.g., user-friendly) for a data processing system (e.g., the force-measuring device 850A and/or the force-measuring device 850B) and/or a hardware interface for attaching peripheral devices (e.g., a flash drive).

FIG. 9 is a two-dimensional vertical diagram of a vehicle 900 having a capacitive sensor module 950 and an airbag control module 922, according to one embodiment. The vehicle 900 (e.g., an automobile) also includes an occupant 902, a temperature module 904, a front seat 906, a back seat 908, a airbag deployment module 924, and an electronic circuit module 960. The front seat 906 and the back seat 908 are mounted on a floor of the vehicle 900. The capacitor sensor modules 950A and 950B are mounted under the front seat 906 and the back seat 908 of the vehicle 900 to weigh the occupant 902.

The temperature module 904 (e.g., a heat detection module) may be installed to cover a substantially large area of the front seat 906 and/or the back seat 908. Here, the temperature module 904 does not just measure a temperature of the occupant 902 but tracks a position of the occupant 902 as well. The electronic circuit module 960 may generate a classification data based on processing of the weight (e.g., obtained using the on-board vehicle seat capacitive force-measuring device 300 of FIG. 3) of the occupant 902 and a body temperature of the occupant 902. Based on to the classification data (e.g., indicating who is in the front seat 906 and/or the back seat 908), the airbag module (e.g., combining functions of both the airbag control module 922 and the airbag deployment module 924) may dispense the airbag toward a direction of the occupant based on the classification when the vehicle 900 is in a crash situation (e.g., when the vehicle 900 running into a brick wall reaches a speed of 10 to 15 miles an hour).

In one example embodiment, the vehicle 900 may deploy an airbag which has been conditioned (e.g., modified, customized, etc) for the occupant 902 with a proper size and a right direction to substantially reduce an injury to the occupant 902. The heat detection system (e.g., the temperature module 904) of the vehicle 900 covering a substantial surface of the front seat 906 and/or the back seat 908 may be able to increase an accuracy of locating a position of the occupant 902 through registering heat generated by a body of the occupant 902. Furthermore, a machine vision module may be used as a sensor coupled to the electronic circuit module 960 to collect and communicate a physical movement of the occupant 902 to generate the classification data with a minimal error.

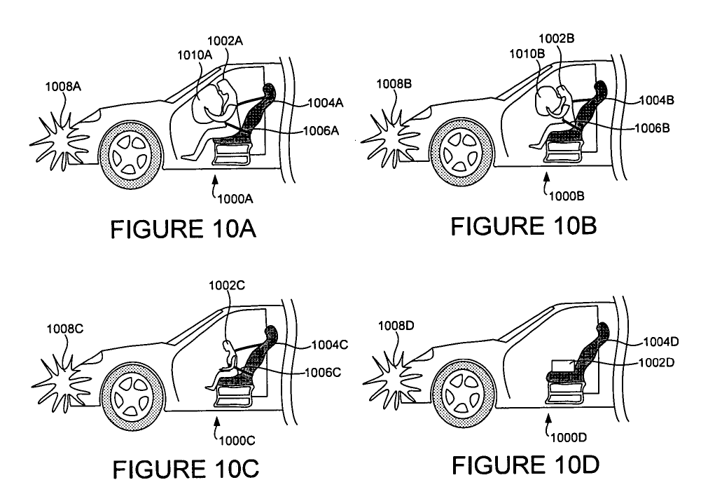

FIGS. 10A-D are illustrative diagrams of four different types of occupants 1002 in a crash 1008, according to one embodiment. In one example embodiment, FIG. 10A includes a vehicle 1000A, an occupant 1002A, a seat 1006A, a crash 1008A, and an airbag 1010A. The crash 1008A may be felt by the vehicle 1000A (e.g., which may trigger sensors to detect the crash 1008A when the sensors receive information from an accelerometer built into a microchip), and the airbag 1010A may be deployed while being inflated with nitrogen gas. Here, a full-deployment of the airbag 1010A may be called for because the occupant 1002A is an adult who is not being too close to either a dashboard or a steering wheel of the vehicle 1000A.

In another example embodiment, FIG. 10B includes a vehicle 1000B, an occupant 1002B, a seat 1006B, a crash 1008B, and an airbag 1010B. The crash 1008B may cause the vehicle 1000B to deploy the airbag 1010B as the airbag is being inflated with nitrogen gas. Here, the airbag 1010B may be inflated half-full because the occupant 1002B may be an adult with a physical condition (e.g., short) who may be too close to a dashboard or a steering wheel of the vehicle 1000B.

In yet another example embodiment, FIG. 10C includes a vehicle 1000C, an occupant 1002C, a seat 1006C, a crash 1008C, and an airbag 1010C. Here, the airbag 1010C may not be deployed because the occupant 1002C may be a child who may be too close to a dashboard or a steering wheel of the vehicle 1000C or too delicate to withstand a full blown airbag with a quick deployment. FIG. 10D includes a vehicle 1000D, an occupant 1002D, a seat 1006D, a crash impact 1008D, and an airbag 1010D. Here, the airbag 1010D may not be deployed because the occupant 1002D may be an inanimate object which may not require any protection. If the airbag 1010D were to deploy in this case, an owner of the vehicle 1000D may have to visit an automobile dealer to reconstruct the airbag 1010D at a cost.

FIG. 11 is a flow diagram of classifying an occupant of a vehicle seat to a category and deploying an airbag based on the category, according to one embodiment.

In operation 1102, a weight data (e.g., based on a weight of an occupant) may be generated based on a functional algorithm (e.g., addition, subtraction, multiplication, and/or division) that considers capacitances produced from a plurality of capacitive sensors (e.g., the force-measuring device 150 of FIG. 1) mounted under a vehicle seat when a weight of an occupant is applied on the vehicle seat. In operation 1104, a position (e.g., a posture, a stance, etc.) of the occupant relative to the vehicle seat may be calculated (e.g., plotted, estimated, obtained, etc.) based on the weight data and a sensory data of the occupant. The occupant may be classified in operation 1106 to a category (e.g., an adult, a young adult, a child, an infant, an inanimate object, etc.) based on the weight data.

In operation 1108, a crash data may be processed (e.g., possibly triggering a deployment of an airbag) in an occupant protection module when a vehicle having the vehicle seat crashes to generate the crash data. An inflation rate of the airbag, a direction of the airbag, and a decision as to the deploying the airbag may be instantaneously determined when the crash data is communicated to the occupant protection module in operation 1110. An airbag may be deployed in operation 1112 based on the category, the position, and the crash data. An audible warning message (e.g., in voice and/or alarm sound) may be generated when the weight of the occupant in a front passenger seat is lighter than a threshold value (e.g., 35 lb).

Although the present embodiments have been described with reference to specific example embodiments, it will be evident that various modifications and changes may be made to these embodiments without departing from the broader spirit and scope of the various embodiments. For example, the temperature module 404, the other data module 406, the detector module 408, the converter module 410, the position module 416, the aggregation module 418, the classification module 420, the other module 424, the airbag control module 422, and other control device 428 of FIG. 4, the sensor 502, the capacitance-to-voltage module 508, the capacitance-to-frequency module 510 of FIG. 5, the transmitter/receiver circuit 808, the wireless interface controller 810, and/or the alarm circuit 814 of FIG. 8 described herein may be enabled and operated using hardware circuitry (e.g., CMOS based logic circuitry), firmware, software and/or any combination of hardware, firmware, and/or software (e.g., embodied in a machine readable medium).

For example, the temperature module 404, the other data module 406, the detector module 408, the converter module 410, the position module 416, the aggregation module 418, the classification module 420, the other module 424, the airbag control module 422 of FIG. 4, the capacitance-to-voltage module 508, and/or the capacitance-to-frequency module 510 of FIG. 5 may be enabled using software and/or using transistors, logic gates, and electrical circuits (e.g., application specific integrated ASIC circuitry) such as a temperature circuit, a detector circuit, a converter circuit, a position circuit, an aggregation circuit, a classification circuit, an airbag control circuit, a capacitance-to-voltage circuit, and/or a capacitance-to-frequency circuit. In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. An apparatus, comprising:
a plurality of capacitive sensors mounted between a base structure of a seat in a vehicle and rails of the seat with each of the plurality of capacitive sensors including:
a capacitor having an upper conductive surface and a lower conductive surface substantially parallel to the upper conductive surface;
a housing with a cover plate to encompass the capacitor; and
a sensor in the housing to generate a measurement based on a change in a distance between the upper conductive surface and the lower conductive surface when the cover plate is deflected by a force applied on the cover plate;
and
an airbag associated with the seat to deploy based on at least a weight of an occupant of the seat obtained by aggregating the measurement.

2. The apparatus of claim 1 further comprising an electronic circuit coupled to the plurality of capacitive sensors using at least one of a wired communication and a wireless communication.

3. The apparatus of claim 2 further comprising a converter circuit of the electronic circuit to transform the measurement to a signal data including at least one of a voltage data and a frequency data.

4. The apparatus of claim 3 further comprising an aggregation circuit of the electronic circuit to sum the signal data from the converter circuit to obtain the weight of the occupant.

5. The apparatus of claim 4 further comprising a detector circuit of the electronic circuit to generate a flag data when a temperature of the occupant measured by a temperature sensor installed on an outer surface of the seat matches a body temperature of a human.

6. The apparatus of claim 5 further comprising a classification circuit of the electronic circuit to categorize the occupant based on at least the weight of the occupant when the flag data is communicated to the classification circuit.

7. The apparatus of claim 6 further comprising a position circuit of the electronic circuit to approximate a posture of the occupant based on a distribution of the weight of the occupant across the plurality of capacitive sensors.

8. The apparatus of claim 7 wherein the posture of the occupant is estimated using a smart sensor based on at least one of an electrical field system to provide a real time analysis of the occupant's position as well as a mass of the occupant and an ultrasound system to determine an identity of the occupant using a high-frequency sound and an echo.

9. The apparatus of claim 7 further comprising an airbag control circuit coupled to the classification circuit to evaluate the weight and the posture of the occupant to deploy the airbag associated with the seat.

10. The apparatus of claim 1 wherein four capacitive sensors are mounted between the base structure of the seat and the rails of the seat wherein the each of the plurality of capacitive sensors is designed to measure at least 200 pounds.

11. A method, comprising:
generating a weight data based on a functional algorithm that considers capacitances produced from a plurality of capacitive sensors mounted under a vehicle seat when a weight of an occupant is applied on the vehicle seat;
calculate a position of the occupant relative to the vehicle seat based on the weight data and a sensory data of the occupant obtained from a plurality of sensors;
classifying the occupant to a category based on the weight data;
processing a crash data in an occupant protection module when a vehicle having the vehicle seat crashes to generate the crash data; and
deploying an airbag based on the category, the position, and the crash data.

12. The method of claim 11 wherein the sensory data includes at least one of a visual data, an olfactory data, a textile data, an acoustic data, and a thermal data of the occupant obtained using a plurality of sensor modules.

13. The method of claim 12 wherein the category comprises at least an adult, a small adult, a child, and an inanimate object.

14. The method of claim 13 further comprising instantaneously determining an inflation rate of the airbag, a direction of the airbag, and a decision to the deploying the airbag when the crash data is communicated to the occupant protection module.

15. The method of claim 14 comprising generating an audible warning message when the weight of the occupant in a front passenger seat is lighter than a threshold value.

16. The method of claim 11 in a form of a machine-readable medium embodying a set of instructions that, when executed by a machine, cause the machine to perform the method of claim 11.

17. A vehicle, comprising:
a seat mounted on a floor of the vehicle;
a capacitive sensor module mounted under the seat of the vehicle to measure a weight of an occupant of the seat;
an electronic circuit module coupled to the capacitive sensor module to generate a classification data associated with the weight of the occupant and the body temperature of the occupant;
a heat detection module installed on a cover of the seat to measure and communicate a body temperature of the occupant to the electronic circuit module; and
an airbag module to dispense an airbag toward the occupant based on the classification data when a crash sensor receives a trigger data from an accelerometer of the vehicle.

18. The vehicle of claim 17 wherein a size and a direction of the airbag toward the occupant are controlled based on the classification data to substantially reduce a propagation of an impact absorbed by the vehicle to the occupant.

19. The vehicle of claim 18 wherein the heat detection module is installed on a substantial surface of the seat and on a seat-belt of the seat to analyze a position of the occupant when a body of the occupant registers heat on the heat detection module.

20. The vehicle of claim 18 further comprising a machine vision module of the vehicle to collect and communicate a physical movement of the occupant to generate the classification data with a minimal error.
